(19) United States
(12) Patent Application Publication
(10) Pub. No.: US 2006/0078412 A1
(43) Pub. Date: Apr. 13, 2006

(54) Apparatus for storing material

(75) Inventor: Ronald T. Hagemann, Leaf River, IL (US)

Correspondence Address: REINHART BOERNER VAN DEUREN LTD., 483 NORTH MULFORD ROAD, SUITE 7, ROCKFORD, IL, 61107, US

(73) Assignee: Rapco L.L.C., Rochelle, IL (US)

(21) Appl. No.: 10/961,730

(22) Filed: Oct. 8, 2004

(51) Int. Cl. B60P 1/04

(52) U.S. Cl. 414/467

(57) ABSTRACT

A new storage apparatus is provided which includes a rectangular box-like containment vessel in which a false movable floor is provided over the bottom floor. A dunnage bag or other actuator is provided to selectively raise and lower the false floor to facilitate self-evaluation and discharge of dry flowable material through a discharge port. The false floor structure may be removed to provide for versatility and different storage options. For example, the containment vessel can be left empty to provide for storage of other objects through openable doors or a pillow tank may be installed within the containment vessel to provide for liquid holding capabilities.

### FIELD OF THE INVENTION

The present invention generally relates to containers and storage devices, and more particularly relates to apparatus which can contain and dispense generally dry material and/or may be modular for providing multiple different storage options.

### BACKGROUND OF THE INVENTION

There are a wide variety of storage vessels that are commonly used in the storage and transportation industries. As applied to flowable materials (e.g. grain, rock salt, and the like) often storage vessels will be in the form of a hopper with slanted sidewalls which converge toward a discharge port. The discharge port will be associated with a closure device such as a gate which may be opened and closed to selectively retain or discharge material from the hopper. While such structures are widely used, there are several deficiencies with this type of a storage device, which will become more apparent once the present invention is understood. First, the slanted sidewalls must be fixed at a steep enough incline to facilitate gravitational flow of material, and as applied to different materials, different slopes may be necessary. Thus, one shape of a hopper may not be suitable for multiple different types of materials. Additionally, by sloping the sidewalls away from a bottom discharge port, the area used to create the slope occupies potential storage volume and thereby decreases the overall storage volume of a particular storage device. Additionally, these types of storage devices are not versatile or modular and can typically only be used for one type of an application, such as holding and discharging dry flowable materials, and cannot be readily utilized to store other objects and/or materials which are not necessarily dry and flowable.

In this regard, it has been found that there are a wide variety of different commercial operations that have different types of storage needs, and storage needs that may change over time. For example, municipalities may need to store rock salt for winter use, but in the summertime may have different storage needs. Similarly, different types of warehouses and other types of operations have storage needs that can change over time and/or be seasonal. The problem with many of the storage vessels currently available in the market is that they are not readily adaptable or applicable to such different storage needs. As a result, commercial operations may need to have many different types of storage vessels, some of which may remain idle for a long period of time. Not only is this generally inefficient, but it requires additional space to store such idle storage vessels.

Accordingly, there are a wide variety of different deficiencies in the prior art which are improved upon and solved by the present invention.

### BRIEF SUMMARY OF THE INVENTION

There are several different aspects of the present invention.

One aspect of the present invention is directed toward an apparatus for storing material which includes a movable floor that can be raised and lowered by means of an inflatable bag to gravitationally discharge materials contained in a liner through a discharge port. This storage apparatus includes a containment vessel having a top and a bottom spaced below the top, and an outer sidewall extending generally around a periphery of the top and bottom and vertically between the top and the bottom. A liner in the storage apparatus contains material in the vessel. The liner is at least partially carried by the movable floor and provides a discharge port. The movable floor is arranged along the bottom of the containment vessel and includes a distal end spaced laterally from the discharge port and a proximate end arranged between the distal end and the discharge port. An inflatable bag is arranged at the bottom and under the movable floor approximate the distal end thereof. The inflatable bag has an inflated position raising the distal end of the movable floor for gravitationally conveying material through the discharge port when in the open state.

Another aspect of the present invention is directed toward an apparatus for storing material which comprises a movable “false” floor that can be raised and lowered over a bottom floor. The movable floor may be lowered to be generally flat and/or may be removed to provide for different operational modes. The apparatus comprises a containment vessel having a top, a bottom floor spaced below the top and an outer sidewall extending generally around a periphery of the top and the bottom floor and extending vertically between the top and the bottom floor. A discharge area is provided at a lower portion of the containment vessel where material contained in the vessel may be discharged. The movable floor is disposed on top of the bottom floor and is movable between raised and lowered positions by appropriate means (e.g. such as an inflatable bag, or other such pneumatic, hydraulic, electric or mechanical actuator) to gravitationally assist material toward the discharge area.

Other aspects, objectives and advantages of the invention will become more apparent from the following detailed description when taken in conjunction with the accompanying drawings.

### BRIEF DESCRIPTION OF THE DRAWINGS

FIGS. 1 and 2 are perspective views of a storage apparatus according to an embodiment of the present invention, with the doors being closed in FIG. 1 and open in FIG. 2 (with a partial cutaway being done in FIG. 2 to expose different structures, with the gate open and the liner chute released for material discharge).

FIG. 3 is a cutaway illustration of the storage apparatus shown in FIGS. 1 and 2 that better illustrates the internal components of such a storage apparatus.

FIG. 4 is similar to FIG. 3 but showing the dunnage bag inflated, which raises the movable floor to gravitationally feed material toward the discharge port.

FIGS. 5 and 6 are cross-sections of the storage apparatus showing the lowered and the raised position for the movable floor, and the liner chute secured and released, respectively to close and open the discharge port.

FIG. 7 is a cross-section similar to FIGS. 5 and 6, except for the fact that the liner has been removed and that a pillow tank system has been installed inside the outer containment vessel.

FIG. 8 is a cross-section view of the containment vessel with the false floor and dunnage bag actuation system removed.

FIG. 9 is a perspective view of a liner for installation and use with the storage apparatus shown in FIGS. 1-5.

FIG. 10 is a perspective illustration showing the storage apparatus mounted on a truck and oriented for dispensing rock salt onto a roadway surface.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Referring to the figures, an embodiment of the present invention is depicted as a storage apparatus, which may be used to store a wide range of different materials (including liquids, generally dry flowable fluid materials such as grains, granular material, salt, etc.) and also for storing objects. As shown in the figures, a storage apparatus 10 includes a containment vessel 12 which provides the structural support and integrity of the storage apparatus 10. The containment vessel 12 is preferably a generally rectangular boxlike structure and may include a total of six different sides. As oriented according to the typical orientation, the containment vessel generally includes a top (which may be open, but is preferably enclosed and fully covered to include a top panel or ceiling), a bottom floor 16 spaced vertically below the top 14 and a sidewall 18 that extends perpendicularly between the top and the bottom floor and around the perimeter of the containment vessel 12. The sidewall 18 may include several different sides including front and back walls 20, 22 and end walls 24 on either side extending perpendicularly between the front and the back walls 20, 22.

It should be noted that each of the different six walls or sides which form the containment vessel 12 can be pulled apart from each other such that the containment vessel is collapsible and can be laid flat. Also, it should be noted that for reference purposes the front wall 20 has been designated as that wall which provides for a discharge area 26. The discharge area 26 is located proximate a lower portion of the containment vessel 12 (e.g. either at or near the bottom of the sidewall 18 and/or through the bottom floor 16). Additionally, one of the different walls which make up the sidewall 18 may include an openable door structure 28 which in this case includes a pair of doors 30, 32 which are hinged about a vertical axis and swing outwardly and inwardly toward each other. The doors may be locked together in a closed position by an appropriate lock mechanism 34 to keep the doors shut and the containment vessel 12 enclosed. However, it should be noted that the doors 30, 32 may be used when it is desired to store other types of objects and large objects in the containment vessel 12, thus providing a modular feature of the containment vessel. In particular, workers can enter and exit the containment vessel 12 through the doors 30, 32. The doors also provide access to the discharge area 26.

To provide for structural support, it should also be noted that the various walls are associated with various integral vertical support members 36 and horizontal support members 38 which provide a structural support cage for providing structural integrity to the overall storage apparatus 10. Additionally, the bottom floor 16 is formed with a bottom panel 40 that is supported upon horizontal and vertical support members 36, 38. The bottom floor 16 is constructed so as to form forklift openings 42 which are configured, sized and structurally supported so as to provide for the reception of the front forks of a forklift vehicle or crane mechanism to facilitate lifting and mobilizing the entire storage apparatus 10. Horizontally between the forklift openings 42 is a central channel 44 which is constructed and configured to be received on a corresponding projecting center rail of an appropriate truck vehicle 46. Truck vehicles 46 of this type are well known and may used for loading and off-loading garbage collection vessels. The center rail 48 of such transport truck vehicles 46 can be received into the central channel 44 and locked thereto so as to provide for ready truck transport of the storage apparatus 10. The central channel 44 and/or the forklift openings 42, or other such suitable mounts may be also used to secure the storage apparatus to rail vehicles, boats, or other such transportation vehicles as appropriate.

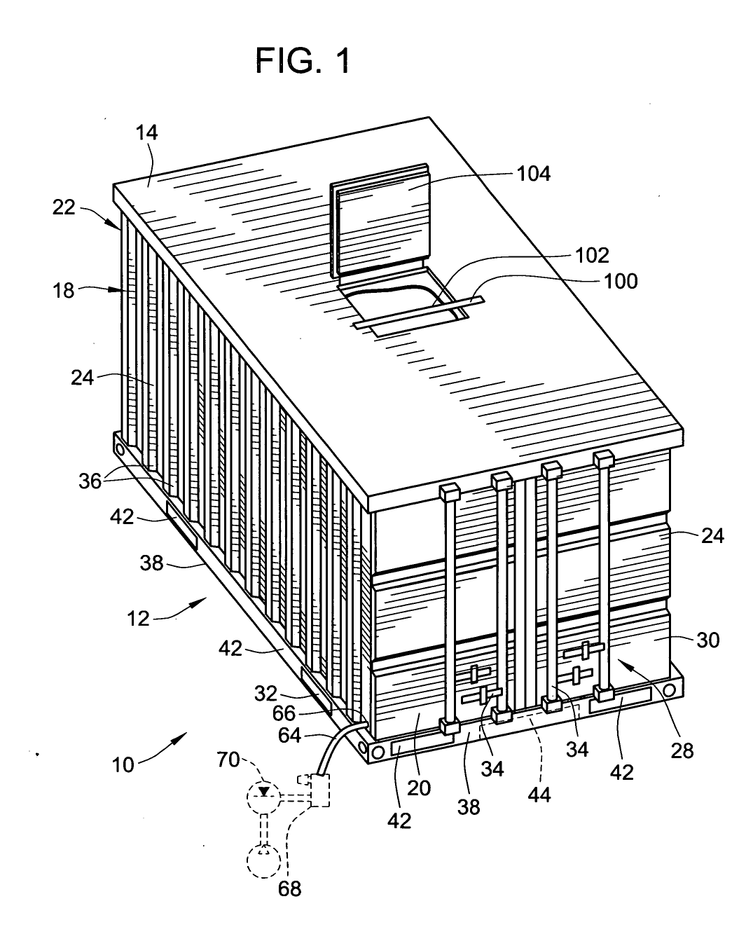

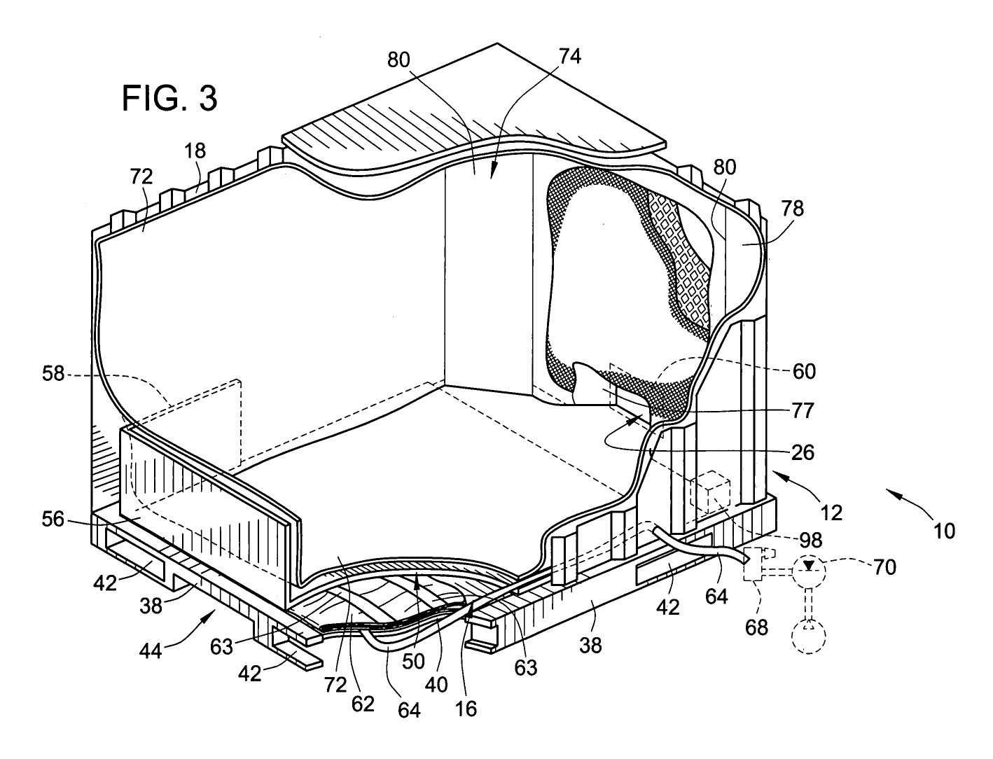

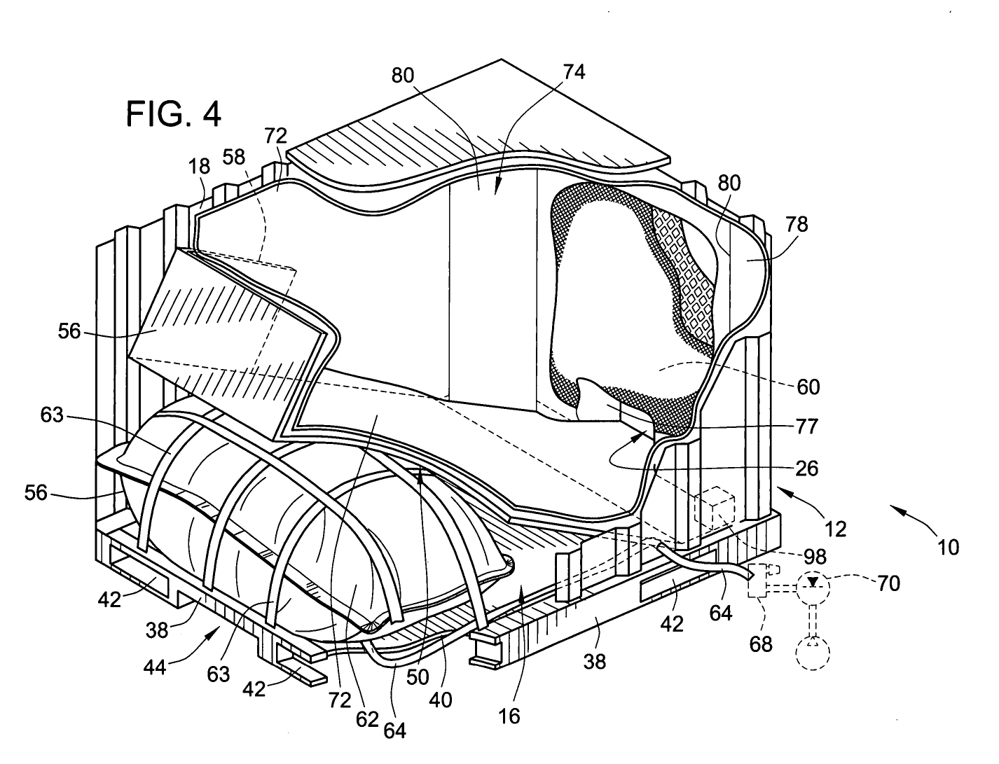

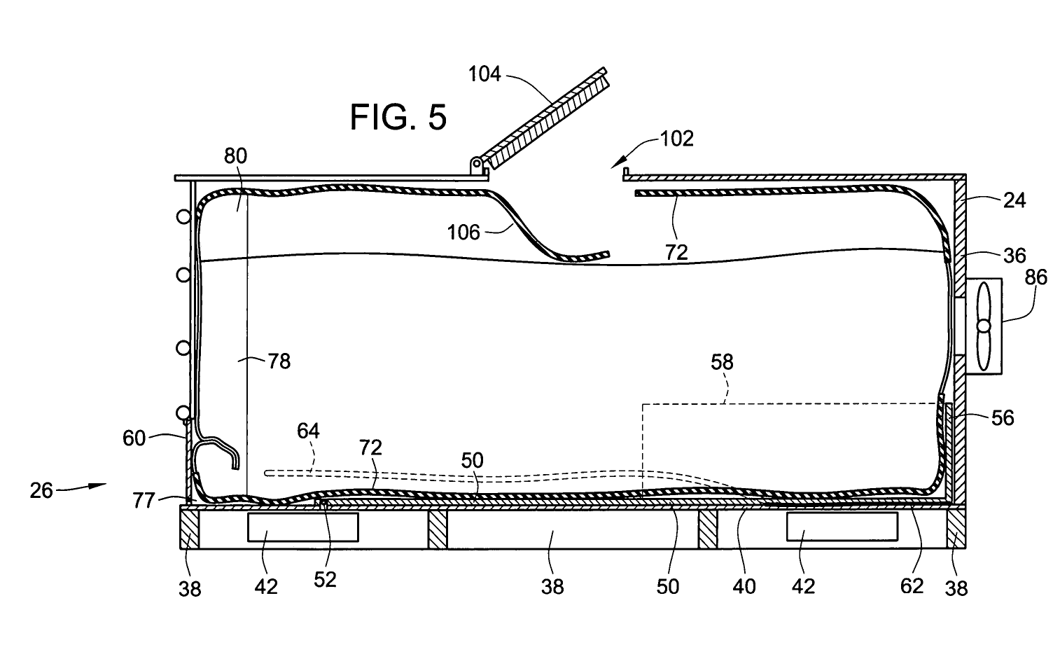

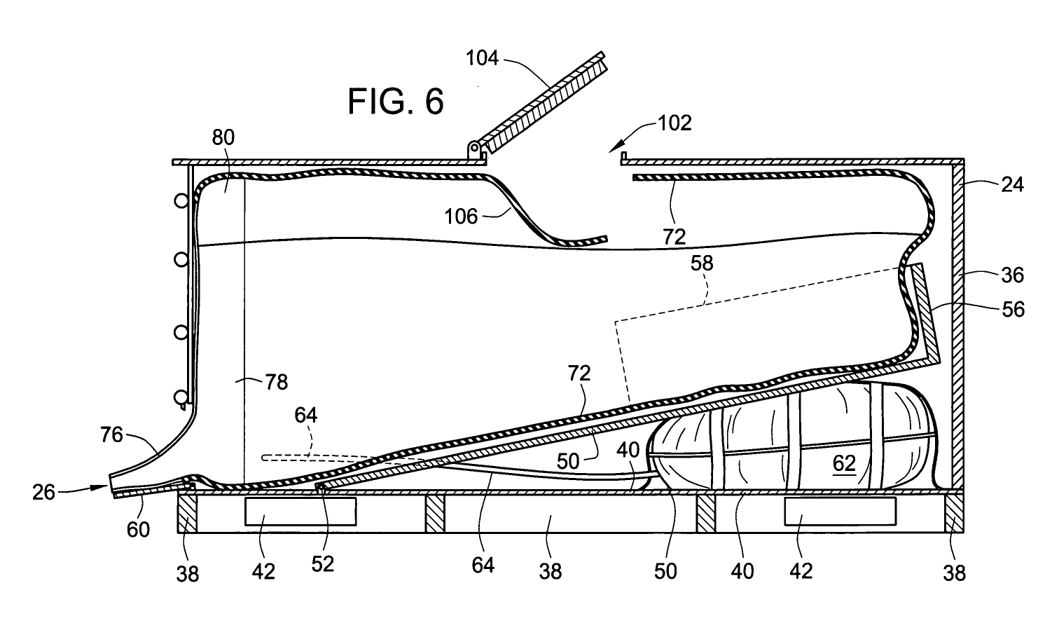

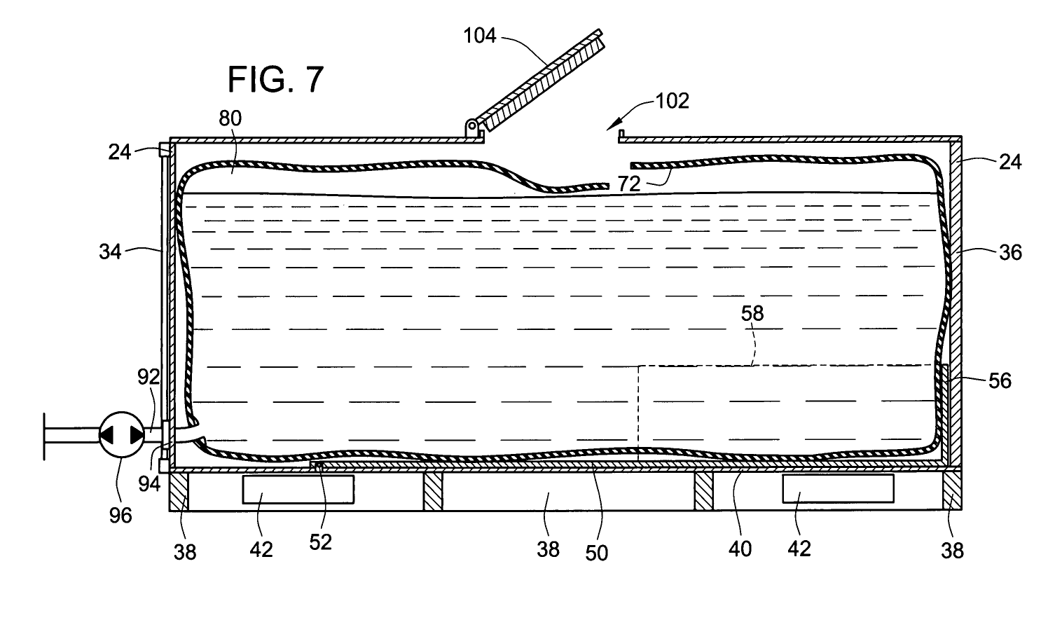

Turning attention to FIGS. 1-6, one of the significant aspects of the present invention is directed toward the provision of a movable floor 50 positioned on top of the bottom floor 16. The movable floor 50 may be raised and lowered as shown in FIGS. 4 and 5 to thereby gravitationally convey flowable material contained in the storage apparatus 10 toward the discharge area 26. The movable floor 50 can be pivotably connected to the containment vessel 12 by means of a hinge 52. The hinge 52 may be located and slightly displaced rearwardly from the discharge area 26 as shown to provide sufficient clearance for the pivoting movement of the movable floor 50.

The movable floor 50 includes box-like support back structure 54 on its back end to include a rear support wall 56 and a pair of opposed side support walls 58 on opposed sides of the rear support wall 56. The support back 54 extends vertically only a portion of the overall vertical height of the containment vessel 12 so that as the movable floor 50 is raised, the support back 54 does not interfere with the ceiling or top panel 55 which is disposed at the top 14 of the containment vessel 12. The side support walls 58 only extend forwardly part of the way from the rear end wall also for interference prevention reasons and also because these side support walls need not extend all of the way to provide the proper support for material during the pivoting movement. The support back 54 is tall enough and long enough to provide sufficient support during pivoting movement to prevent dry flowable material (such as grain or salt) from spilling over the back side of the support wall. In particular, when dry flowable material is contained in the containment vessel 12, pivoting movement of the movable floor structure 50 tends to draw the back end of the movable floor 50 away from the rear back wall 22 of the containment vessel 12. This in turn may create the possibility for material to spill along the back side of the movable floor and thereby impede raising and lowering of the movable floor 50. The support back 54 thus prevents such failure.

In this regard, it should be noted that upon initial opening of the discharge area 26 by means of a gate 60 (and opening of the discharge port) that dry flowable material will automatically start to evacuate and discharge from the containment vessel 12. The natural force of gravity causes material to discharge while the discharge area is open, until a natural slope for a given material is established inside the vessel. The movable floor 50 needs to be raised only when material ceases to flow from the container. This occurs when the material level is substantially lower. This is another reason why the support back 54 thus need not extend all the way toward the top 14. In any event, the support back 54 is sufficiently tall enough to prevent such grain, salt or other granular material or other such flowable material from spilling over the back side of the support wall and interfering with the pivoting movement and raising and lowering of the movable floor 50.

To facilitate raising and lowering of the movable floor and the pivoting movement thereof about the hinge 52, an actuation mechanism is provided which may take the form of a inflatable dunnage bag 62, or other appropriate actuator. The dunnage bag 62 is placed between the movable floor 50 and the bottom floor 16. The dunnage bag 62 is preferably secured to the containment vessel by straps 63 that extend across the dunnage bag and that have opposed ends secured to the vessel. The straps 63 prevent the dunnage bag from shifting around and moving out of position. When the dunnage bag 62 is deflated, it takes up very little volume and lies substantially flat such that the movable floor 50 lies substantially flat with little or no incline upon the bottom floor 16. However, as the dunnage bag 62 is inflated, the dunnage bag 62 expands thereby taking up volume and raising the distal end of the movable floor 50 about the hinge 52 to thereby provide for pivoting movement. With the movable floor raised, an inclined or sloped surface is created along the bottom support surface in the containment vessel which causes material to slide and gravitationally be conveyed toward the discharge area 26. While a dunnage bag 62 is illustrated in a preferred embodiment and has significant advantages from economy, mounting, and removability, other aspects of the present invention are intended to be broader to incorporate other such actuation means to include hydraulic actuators, other forms of pneumatic actuators, electrical actuators and the like.

It should be noted that the gradual expansion of the dunnage bag 62 allows for a relatively low power source to be used in order to gradually raise the movable floor 50. Because the dunnage bag 62 is spread out horizontally over an extended area typically substantially along the entire width between end walls 24, the work can be spread out over a large region thereby decreasing the amount of powering requirements necessary to inflate the dunnage bag 62 and thereby raise the movable floor 50 about the hinge 52.

To controllably inflate the dunnage bag, the dunnage bag 62 is connected by way of a pneumatic line 64 that extends through a port hole 66 in the containment vessel 62 to an appropriate control valve 68 and a compressed air source 70 such as a pressure pot as shown and/or a compressor. As shown, the pressure line 64 may be routed internally along an inner rectangular periphery and through a metal protective conduit to the port hole 66 in a formed part of the vessel. The valve 68 can be electrically operated in a remote manner or may alternatively be manually operated in order to facilitate inflation and deflation of the dunnage bag 62 and thereby raise and lower the movable floor 50. In the terms of the transport vehicle 46, this may be particularly useful when it is desired to use the containment vessel 12 for such applications as applying salt on roadways. In such application remote electronic control over the valve 68 (e.g. via solenoid operated valves) can provide for raising the movable floor during operation so as to progressively move salt toward the discharge region. In such an application, typically the pneumatic line 64 will be attached to the compressed air source of such a vehicle 46.

With this being said, another feature of the present invention is that when many containment vessels 12 are situated side by side and it is desired to empty them in sequence, a single compressor may be systematically and successively connected and deconnected from each of the different dunnage bags or the different containment vessels to sequentially empty each of the different containment vessels. Thus, a separate compressed air source and/or control valve need not be dedicated to a single containment vessel but may be shared among multiple different containment vessels.

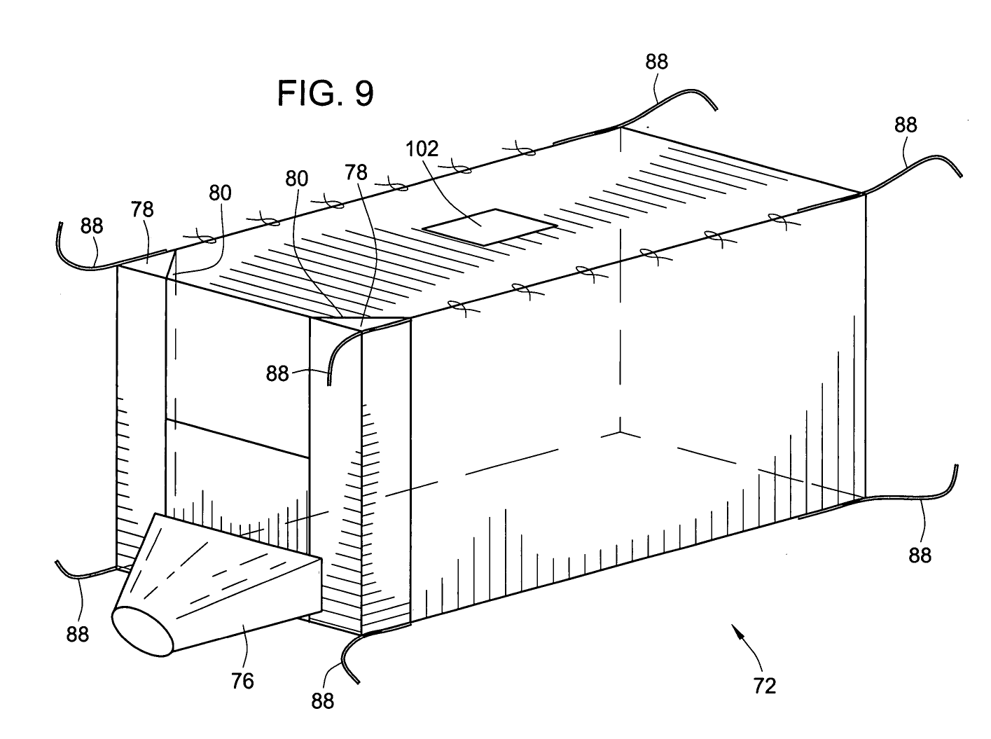

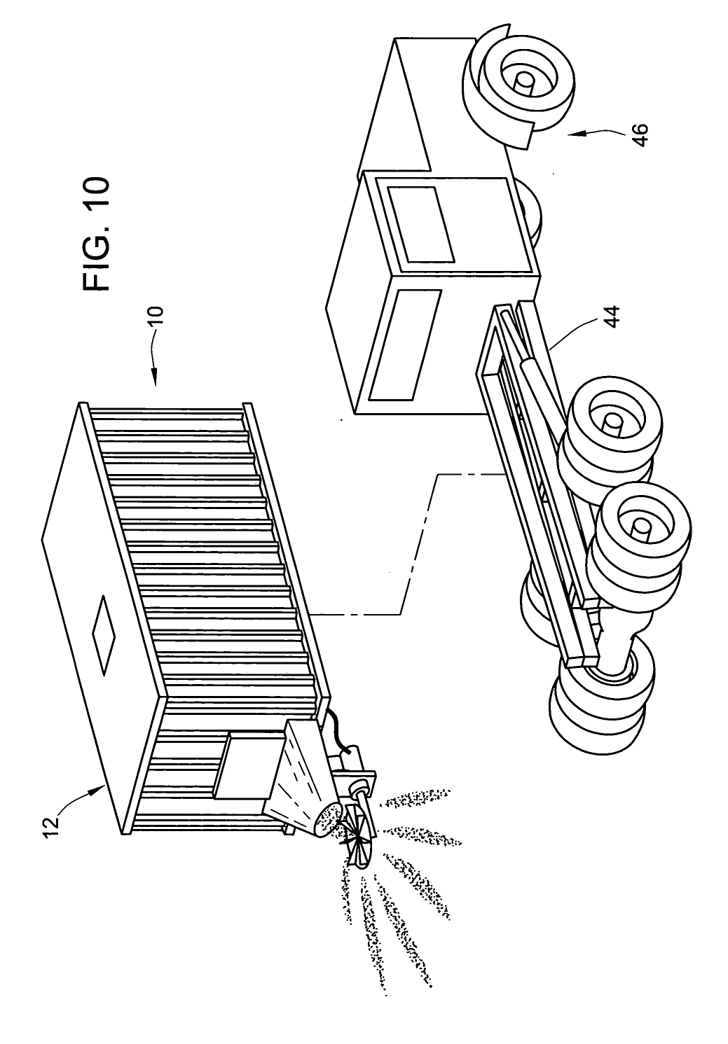

A further feature of the present invention is the provision for a liner 72 which is shown in the various cross-sectional figures, but is also shown in greater detail in FIG. 9. The liner 72 provides a generally enclosed internal chamber in which the material is contained and protected. The liner 72 may be used to act as a separation between the containment vessel 12 and may be used to seal the material contained therein. The liner 72 has a rectangular box like shape that is generally complimentary to that of the containment vessel 12 such that in its expanded state it has a storage capacity that is complimentary to the internal volume of the containment vessel such that all or most of the storage volume afforded by the containment vessel 12 is utilized.

The liner 72 includes a discharge chute 76 which is at the discharge area 26 in the containment vessel 12. The liner 72 defines a discharge port 77 at the discharge area 26 that communicates with the discharge chute 76. The discharge port 77 provides an outlet for material from the containment vessel and liner 72 to exit and discharge to facilitate unloading of the containment vessel. The discharge port 77 may be closed by a gate (not shown) or may be closed by securing extending liner flap which forms the chute 76 (e.g. tying or otherwise securing, trapping the chute flap). In the disclosed embodiment, the discharge chute 76 can be tied up and/or secured behind a gate 112. Furthermore, the liner 72 may include vertical baffles 78 therein which extend vertically and have inclined surfaces that converge toward the discharge port 77 when arranged within the containment vessel.

The liner 72 includes six sides complimentary to that of the containment vessel and may be made up of several different segment portions as shown and are tied together and secured to the containment vessel 12 with ties or suspender loops 88. These suspender loops 88 can be secured to the containment vessel to conform the shape of the liner 72 to the containment vessel 12.

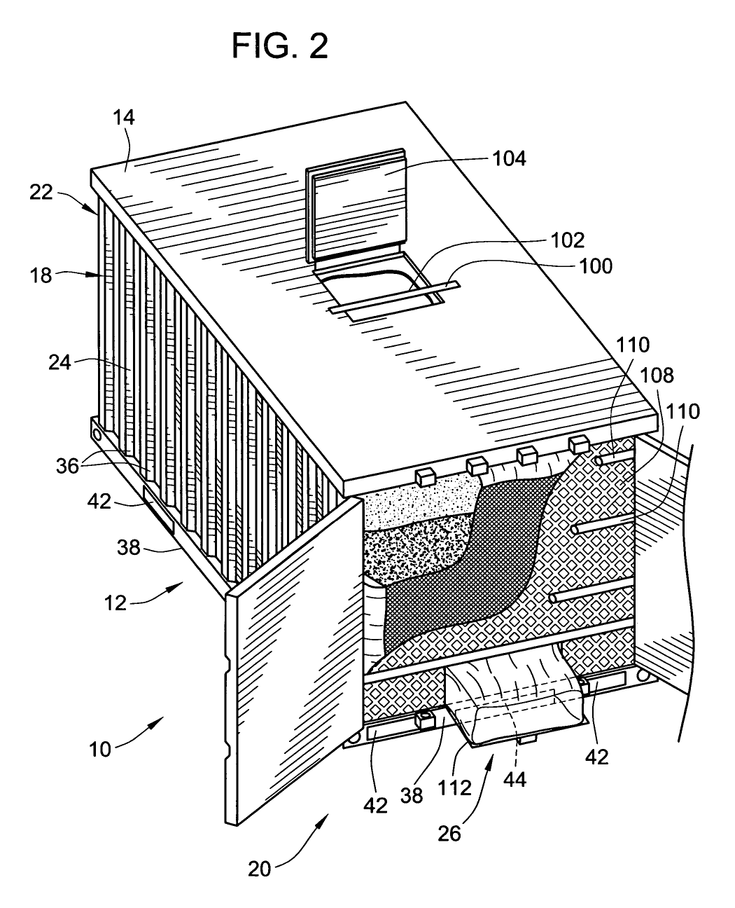

To support the liner 72 at the front end of the containment vessel, when the doors 30, 32 are open as shown in FIG. 2, a front support wall is provided behind the doors 30, 32 which may comprise a perforated support wall or screen 108 that is secured to the vessel walls 24. The support wall may alternatively or also include bulkhead bars 110 that extend between opposed walls 24 horizontally (or vertically between top and bottom walls). An opening or gate 112 may be provided for receiving the chute 76 of the liner 72 therethrough. The gate 112 can be pivoted (or slid) open and closed to permit selecting release or securement of the liner chute 76 as desired. The flap which forms the chute 76 may either be trapped behind the gate and thereby close the discharge port 77 and/or may be tied up to the bars 110 or other such support structure of the vessel to close the discharge port 77. Releasing the chute thereby opens the discharge port to allow for discharge of the container contents. In an alternative embodiment, a rigid material discharge chute may also be mounted on the containment vessel if desired, and/or discharge can be controlled with a feed control gate.

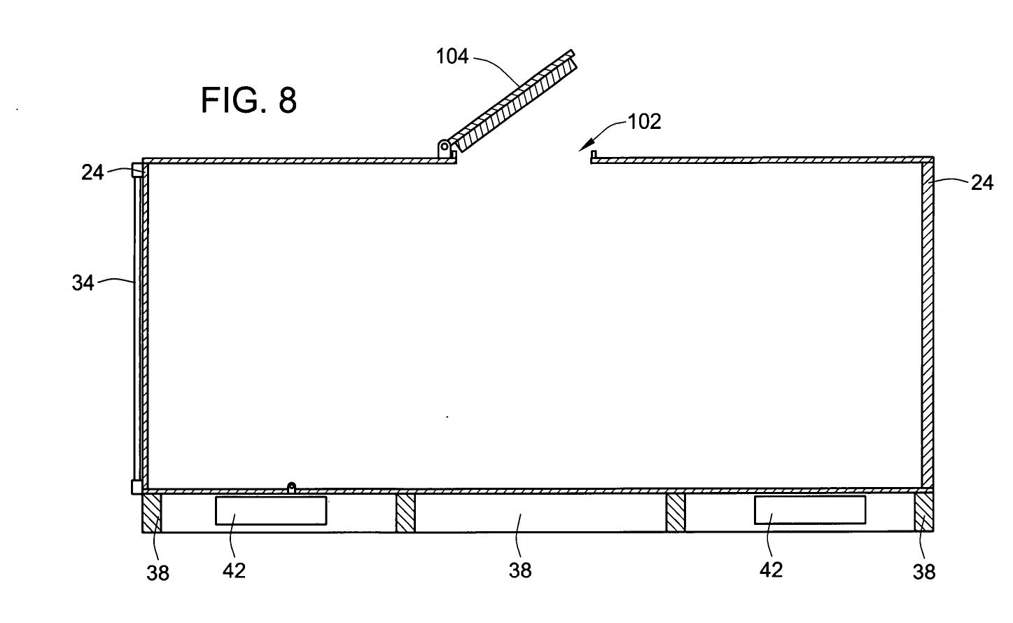

A feature of the present invention is that the liner 72 may be removed (and the movable false floor 50 and dunnage bag 62 may also be removed), to provide for different storage options for the containment vessel. For example, the containment vessel 12 may be kept completely empty as shown in FIG. 8. Additionally, a pillow tank 90 may be installed into the containment vessel 12 with or without the movable false floor 50 present therein. The pillow tank 90 may be filled with liquid and includes a communication conduit 92 which may be communicated through a formed opening 94 in a wall of the containment vessel 12. The communication conduit 92 can be hooked up to a pump 96 to facilitate liquid loading and unloading of the pillow tank.

A further feature of the present invention is the provision for a global positioning system (GPS) 98 and/or a barcode label 100 which may be applied to the storage apparatus. As a result, an end user anywhere in the world can view all of the product activities and the relevant location for the contained product in the storage apparatus 10. The barcode 100 may be installed at least partial along the inside wall of the containment vessel 12 such that it allows an end user to ensure a reliable trace source of the container contents. Although the barcode 100 may also be provided on the outside of the containment vessel 12, providing it on the inside results in great difficulty in attempting to obviate or obstruct the function of the barcode since it would require emptying the container's contents to gain access to the barcode 100. Furthermore, as shown, the bar code labels 100 are arranged to engage doors or gates, which when closed engage the bar code labels 100. Adhesive on the code labels secures the label to the door of the gate such that when opened, the label will tear in a noticeable manner. As a result, the absence of a tear will indicate potential tampering with the container contents.

The tracing system may also be used to provide information via the worldwide web at any time to any end user for all environmental, genetic and management items for the commodity contained inside the container to the actual movement of the container through shipping channels. The GPS 98 provides for such a tracking mechanism 98 (which includes a transreceiver to transmit a signal indicating location). This provides continuous tracking on an ongoing basis so that the position of the containment vessel 12 can be tracked in real time. Again, the GPS 98 is located at a strategic location within the containment vessel 12 as shown such that emptying of the containment vessel 12 would be necessary in order to have access to the GPS, thereby providing for tamper resistance.

Yet a further feature of the present invention may be the provision for a fill port 102 through the top panel or ceiling 55 of the containment vessel 12. A sealable hatch 104 is provided to selectively open and close the fill port 102. The fill port 102 extends through the liner with an openable and closable flap 106 provided therein to allow for access to the internal chamber within the liner 72. The liner 72 may include ties or a zipper to secure the flap 106. The fill port 102 can be used to provide for filling the containment vessel 12 through the top of the containment vessel. This is an advantage, particularly for such applications as grain in which augers and the like typically gravitationally drop dry grain material vertically through-the hatch 104. The hatch 104 would be positioned in the open state to allow filling through the fill port after the containment vessel is filled to close and protect the commodity contained within the containment vessel 12.

Another feature is the provision of a blower 86 that is in communication with a vent port 84 formed into a wall of the containment vessel 12, the blower unit 86 is mounted to the containment vessel 12 and is arranged to pull air through the vessel. Such aeration of the contents of the container may be useful for maintaining the condition of container contents, such as grain. Aeration can prevent moisture from condensing and causing the grain to go bad. The blower unit 86 can be mounted in the rear wall 22 as shown and may be arranged to draw air through the containment vessel. The doors 30, 32 may be opened to facilitate aeration, with the bars 110 and/or screen 108 supporting the liner 76 and allowing air flow therethrough (or breath ports may be provided in the front door with the gap created by the bars 110 or screen 108 permitting air flow). The liner 76 is made of breathable fabric material and may include mesh at the front and back ends with more sizeable pores than the sides to facilitate front to back air flow when this feature is used. The sidewalls of the liner 76 may also be coated with sealant to be less permeable or impermeable.

### FURTHER DETAILS OF AN EXAMPLE

The containerized handling system offers a woven coated baffled liner and a self-evacuation system for dry material or a 500-gallon pillow tank with hydraulic pump for liquid material. This system uses a collapsible 10″×8″×8′ container that allows for easy storage when not used. The container is made of 22-gauge steel and has a four′ wide rear door for evacuation of product. The 2300 pound empty weight container also has a 3/16″ diamond plated floor, is waterproof, can be stacked on each other, rust resistant, powder coated, constructed with fork lift pockets, a dual locking system, and a 36×36 inch hatch located on the top for leading. Filling the inside of the dry material container is a 5 oz. breathable fabric woven coated liner that restricts contamination of the interior contents. Woven suspender loops will be used to hold the liner in place. One center discharge 20″ diameter×30″ long will discharge the product. The container is also equipped with GPS (Global Positioning System) and bar coding that allows the end-use buyer a reliable, traced source of the containers contents. The dry system uses a dunnage bag for the unloading of the container holding 12,000 pounds maximum or 600 cubic feet of contained product. This allows for delivery of the container's contents without the safety issues of using hydraulics and time consumption requirements currently offered in the respective industries that this offering would be targeting. The neoprene 48×96 inch dunnage bag with 1 inch thickness is located underneath a false floor made with 11 gauge steel similar to the safety bars mentioned below. The false floor is basically a box with three sides that run 3 feet up the container walls. The dunnage bag fills with air from a 4-inch valve located on the corner of the bag that goes through the container floor. The unloading process begins as the box begins its 4-foot ascent to a 30-degree angle evacuating the product. Additional safety is offered with the use of 5 steel bars. The bars are carbon 11 gauge steel with mill finish, 0.12 inch thickness, 1.5 inch×1.5 inch×94.5 inch bars behind the door. The metal bar specs are: Material raw steel 37-2, Material (VS Equivalent) ASTM A-36, DIN CODE 2395-S235JRH, Standard BS 6363/83, Tensile Strength MPA 495, Tensile Strength PSI 71799, Bending Strength MPA 350, Bending Strength PSI/YIELD 50767, Elongation 31%.

When evacuating liquid, the pillow tank system will be used. Pillow Tanks are Collapsible, temporary liquid storage containers. They are useful for oil spill recovery operations, bulk liquid transport, storage of bilge slops, or fuel storage. These containers are designed for land-based operations, but can be used on the decks of vessels. The Pillow Tank used in this design has a 500-gallon capacity.

Standard tanks are fabricated with XR-5 B fabric that provides ultraviolet light and chemical resistance. FDA approved vinyl is available for potable water use. The complete Pillow Tank Specs are: Fabric-Sheltherite XR-5 B. Base Fabric-6 oz./sq. yd. nylon, Coated Weight-24 oz./sq. yd., Tongue Tear-125/125 lbs., Trapezoid Tear-60/60 lbs., Grab Tensile-500/400 lbs., Strip Tensile-400/300 lbs., Adhesion-10 lbs./inch, Cold Crack-Minus 30 degrees F. Fill/Drain-Aluminum thread flanges—2 inch. Air Vent/Pressure Relief Valve-Included Seams-All seams are 100% thermal welded using both hot air and RF methods Reparability-Tears or punctures can be easily repaired utilizing hand held guns, repair fabric and a roller Ground Cloths-Are available and recommended. Discharge with 3-hourse power centrifugal poly-pump.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for storing and discharging material, comprising:
a containment vessel having a top, a bottom spaced from the top, and an outer sidewall extending generally around a periphery of the top and bottom and vertically between the top and the bottom;
a liner in the containment vessel, the liner having an internal chamber for surrounding material therein;
a discharge port through a lower portion of the liner for dispensing material;
a movable floor arranged along the bottom, the movable floor carrying at least a portion of the liner, the movable floor including a distal end spaced laterally from the discharge port and a proximate end arranged between the distal end and the discharge port; and
an inflatable bag arranged proximate the bottom and under the floor proximate the distal end, the inflatable bag having an inflated state raising the distal end above the proximate for gravitationally conveying material through the discharge port.

2. The apparatus of claim 1, further comprising a support back integrally connected to the movable floor, the support back including a rear wall projecting vertically from the distal end and a pair of opposed walls spaced on opposed sides of the rear wall, the opposed walls extending forwardly from the rear wall.

3. The apparatus of claim 2, wherein the support back extends a vertical distance that is less than the spacing between the top and bottom such that when the distal end is raised during the inflated state a clearance exists between the support back and the top.

4. The apparatus of claim 1, wherein the sidewall includes at least one door having open and closed positions, further comprising a liner support mounted to the container vessel and behind the at least one door for supporting the liner when the door is in the open position, wherein the discharge port includes an open state and a closed state, the discharge port being arranged in communication with the door for discharging material through the door when in the open position with the discharge port in the open state.

5. The apparatus of claim 4, wherein the liner comprises a flexible material flap at the discharge port, wherein the flexible material flap is secured shut to close the discharge port and released to open the discharge port.

6. The apparatus of claim 5, wherein the flexible material flap forms a discharge chute when released.

7. The apparatus of claim 6, wherein the liner support comprises a perforated wall, further comprising a gate in the perforated wall receiving the discharge chute therethrough when the discharge chute is released.

8. The apparatus of claim 4, wherein said liner supports includes a plurality of spaced apart bars extending across a portion of the containment vessel.

9. The apparatus of claim 1, wherein the bottom includes a bottom floor extending horizontally, and wherein the movable floor is hinged to the to the bottom floor rearward and proximate the discharge port, the movable floor pivoting relative to the bottom via the hinge.

10. The apparatus of claim 6, wherein the inflatable bag is sandwiched between the movable floor and the bottom floor.

11. The apparatus of claim 10, further comprising means for securing the inflatable bag to the bottom floor.

12. The apparatus of claim 1, wherein the containment vessel is a rectangular box like structure comprising a top panel and a bottom panel arranged horizontally parallel, and a pair of front and back walls in spaced relation extending transversely between the top and bottom panels, spaced relation, and a pair of end walls in spaced relation extending transversely between the top and bottom panels and transversely between the front and back walls, further comprising an fill port formed through the top panel, and a closure element having an open state for allowing flow of material through the fill port and a closed state for preventing flow through the fill port.

13. The apparatus of claim 1, further comprising means for tracking contents contained in the containment vessel, said tracking means being contained at least partially in the containment vessel.

14. The apparatus of claim 13, further comprising tamper resistant means for indicating when the contents of the containment vessel when filled and enclosed has been tampered with.

15. The apparatus of claim 1, further comprising a pillow tank, the containment vessel having a first state wherein the pillow tank is contained in the containment vessel for holding liquid and a second state wherein the pillow tank is not contained therein for holding granular material.

16. The apparatus of claim 15, further comprising a third state in which the pillow tank and the movable floor are removed from the containment vessel.

17. The apparatus of claim 1, further comprising baffle means connected to the liner for directing material toward the discharge port.

18. The apparatus of claim 1, further comprising an aeration blower mounted through the containment vessel, the aeration blower being in operable communication with the internal chamber of the liner.

19. An apparatus for storing and discharging material, comprising:
a containment vessel having a top, a bottom floor spaced below the top, and an outer side wall extending generally around a periphery of the top and the bottom floor and vertically between the top and the bottom floor;
a discharge area proximate a lower portion of the containment vessel;
a movable floor on top of the bottom floor, the movable floor having a top support surface; and
an actuator acting upon the movable floor, the actuator operable to raise the movable floor and thereby incline the top support surface with a slope that angles downwardly generally toward the discharge area.

20. The apparatus of claim 19, further comprising:
a liner in the containment vessel, the liner having an internal chamber for surrounding material therein; and
a discharge port through a lower portion of the liner for dispensing material, the discharge port being located at the discharge area.

21. The apparatus of claim 19, further comprising a support back integrally connected to the movable floor, the support back including a rear wall projecting vertically from the distal end and a pair of opposed walls spaced on opposed sides of the rear wall, the opposed walls extending forwardly from the rear wall, wherein the support back extends a vertical distance that is less than the spacing between the top and bottom such that when the distal end is raised during the inflated state a clearance exists between the support back and the top.

22. The apparatus of claim 19, wherein the outer sidewall includes at least one door having open and closed positions, further comprising a liner support mounted to the container vessel and behind the at least one door for supporting the liner when the door is in the open position, wherein the discharge port includes an open state and a closed state, the discharge port being arranged in communication with the door for discharging material through the door when in the open position with the discharge port in the open state.

23. The apparatus of claim 22, wherein the liner comprises a flexible material flap at the discharge port, wherein the flexible material flap is secured shut to close the discharge port and released to open the discharge port.

24. The apparatus of claim 23, wherein the flexible material flap forms a discharge chute when released.

25. The apparatus of claim 24, wherein the liner support comprises a perforated wall, further comprising a gate in the perforated wall receiving the discharge chute therethrough when the discharge chute is released.

26. The apparatus of claim 22, wherein said liner supports includes a plurality of spaced apart bars extending across a portion of the containment vessel.

27. The apparatus of claim 19, wherein the bottom includes a bottom floor extending horizontally, and wherein the movable floor is hinged to the to the bottom floor rearward and proximate the discharge port, the movable floor pivoting relative to the bottom via the hinge.

28. The apparatus of claim 19, wherein the containment vessel is a rectangular box like structure comprising a top panel and a bottom panel arranged horizontally parallel, and a pair of front and back walls in spaced relation extending transversely between the top and bottom panels, spaced relation, and a pair of end walls in spaced relation extending transversely between the top and bottom panels and transversely between the front and back walls, further comprising an fill port formed through the top panel, and an closure element having an open state for allowing flow of material through the fill port and a closed state for preventing flow through the fill port.

29. The apparatus of claim 19, further comprising means for tracking contents contained in the containment vessel, said tracking means being contained at least partially in the containment vessel.

30. The apparatus of claim 29, further comprising tamper resistant means for indicating when the contents of the containment vessel when filled and enclosed has been tampered with.

31. The apparatus of claim 19, further comprising a pillow tank, the containment vessel having a first state wherein the pillow tank is contained in the containment vessel for holding liquid and a second state wherein the pillow tank is not contained therein for holding granular material.

32. The apparatus of claim 31, further comprising a third state in which the pillow tank and the movable floor are removed from the containment vessel.
